(19) United States
(12) Patent Application Publication
(10) Pub. No.: US 2002/0091864 A1
(43) Pub. Date: Jul. 11, 2002

(54) Ring network being installed as bus network

(76) Inventors: Steven Jan Van Raalte, Breda (NL); Marc Peter Smaak, Breda (NL)

Correspondence Address: Corporate Patent Counsel, U.S. Philips Corporation, 580 White Plains Road, Tarrytown, NY, 10591, US

(21) Appl. No.: 10/014,237

(22) Filed: Dec. 11, 2001

(30) Foreign Application Priority Data
Dec. 15, 2000 (EP) 00204600.1

(51) Int. Cl. G06F 15/16

(52) U.S. Cl. 709/251

(57) ABSTRACT

The invention relates to a ring network being installed as bus network comprising: n≧4 nodes 200-1, . . . 200-5; and n−1 cable sections 100-1, . . . 100-5. Each of said cable sections includes a forward line 105-1 . . . 105-4 and a return line 110-1 . . . 110-4. The nodes except the first and the last node of said network are referred to as intermediate nodes. It is the object of the invention to improve such a network such that its total length is enlarged. This object is solved in the way that the network interfaces in said sequential arranged intermediate nodes 200-2 . . . 200-4 are connected alternately between two forward lines 105-1 . . . 105-4 or between two return lines 110-1 . . . 110-4 of the two cable sections being respectively connected to each of said intermediate nodes.

The invention relates to a ring network being installed as bus network according to the preamble of claim 1.

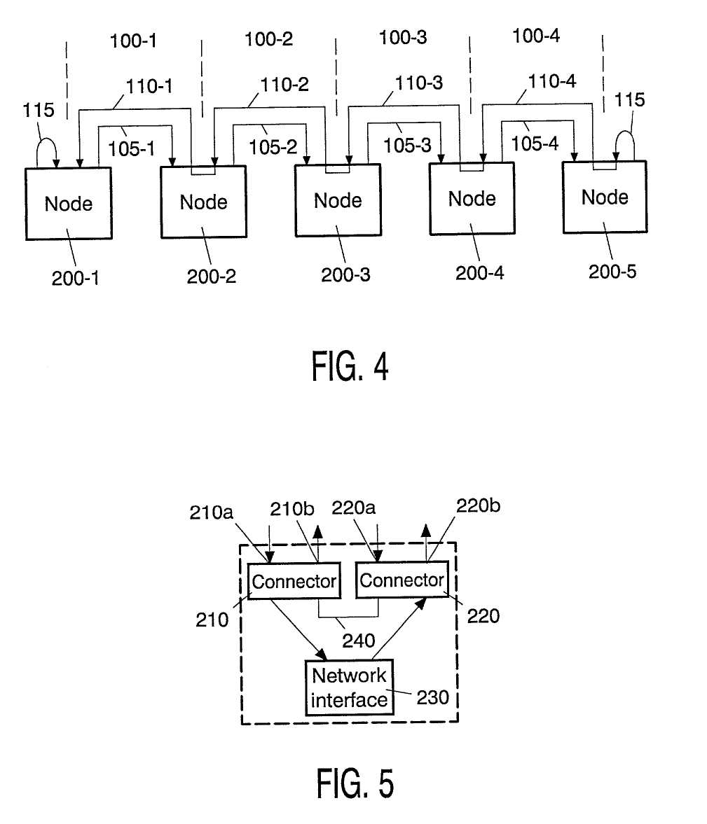

Such ring networks are known in the art and will now be discussed by referring to FIG. 4.

The ring network according to FIG. 4 comprises n=5 nodes 200-1 . . . 200-5 all being connected to a double cable.

Said double cable comprises four cable sections 100-1 . . . 100-4 each of which including a forward line 105-1 . . . 105-4 and a return line 110-1 . . . 110-4 for transmitting a signal in opposite directions within each cable section.

The nodes 200-2, 200-3 and 200-4 are called “intermediate nodes” because they are connected between two of said cable sections 100-1, 100-2, 100-3 and 100-4, respectively. More specifically, they are connected between the forward lines 105-1 . . . 105-4 of said cable sections.

To the contrary the first node 200-1 and the last node 200-5 of said ring network are respectively connected only to one cable section 105-1, 105-4. They both serve for closing the ring network by respectively connecting the return line with the forward line of the cable sections connected to them via loop back terminators 115.

Such a ring network wherein the return lines and the forward lines are included together in one cable is called bus network.

The particular installation shown in FIG. 4 in which the return lines 110-1 . . . 110-4 are lead from the last node 200-5 via the intermediate nodes 200-4, 200-3, 200-2 back to the first node 200-1 of the ring network is preferably used for portable applications.

For enabling operation of the bus network according to FIG. 4 the nodes comprise specific components which shall be illustrated by the example of the intermediate node 200-2 as shown in FIG. 5.

FIG. 5 shows the known intermediate node 200-2 comprising a first connector 210 for connecting said intermediate node to the first cable section 100-1 and a second connector 220 for connecting the intermediate node 200-2 to the second cable section 100-2. More specifically, the first connector 210 comprises a first input terminal 210a for connecting the forward line 105-1 of the first cable section and a first output terminal 210b for connecting the return line 110-1 of said first cable section 100-1 to said intermediate node 200-2. Said second connector 220 further comprises a second input terminal 220a for connecting the return line 110-2 of said second cable section 100-2 and a second output terminal 220b for connecting the forward line 105-2 of said second cable section 100-2 to the intermediate node.

According to FIG. 5 a network interface 230 is connected between said first input terminal 210a and said second output terminal 220b; said network interface 230 is among others used for regenerating signals being send via said forward lines 105-1 and 105-2.

The intermediate node 200-2 further comprises a jumper 240 for connecting the second input terminal 220a with the first output terminal 210b.

All intermediate nodes in the network according to FIG. 4 are embodied identical to the node 200-2 shown in FIG. 5.

It is important to note that in the prior art ring networks according to FIG. 4 the network interfaces 230 in the intermediate nodes 200-2, 200-3 and 200-4 are all connected between the forward lines of the two cable sections connected to them, respectively. Alternatively they might all be connected between the return lines. Said way of installation has the disadvantage that the maximum distance between said nodes is seriously limited; which shall be illustrated by the following example:

Assuming that all the network interfaces 230 in the nodes 200-1 . . . 200-5 regenerate a received signal to the same magnitude or energy before they sent out said signal to the adjacent node in the network there is a fix maximum wiring distance between two nodes; this maximum wiring distance for each return line or forward line is e.g. 50 m.

In that case the maximum length between node 200-1 and node 200-5 in FIG. 4 is only 50 m, because the length of the return line 110 is restricted to 50 m and said return line is included together with the respective forward lines in one double cable. Said restriction is valid although the individual lengths of the forward lines 105-1 . . . 105-4 are allowed to be 50 m respectively, that means 200 m in total.

Starting from that prior art it is the object of the invention to improve a ring network being installed as bus network such that its total length is enlarged.

This object is solved according to claim 1 for a bus network known in the art in that in said at least two sequential intermediate nodes the respective network interfaces are connected alternately between the forward lines and the return lines of said two connected cable sections.

Said specific installation has the advantage that the signal is restored by the network interface in every other node. Expressed in other words in said installation there is only the need to provide one node or network interface between two other nodes which are positioned at the predetermined maximum distance to each other.

As a result the total length of the bus network and the wiring possibilities are enlarged.

According to a preferred embodiment of the invention at least one of the intermediate nodes comprises a multiplexer for connecting the network interface either between the first input and the second output terminal or between the second input and the first output terminal of connectors within said node in response to a control signal. Said embodiment has the advantage that within one intermediate node the connection of the network interface can easily be changed. More specifically, the network interface can either be switched between the forward lines or between the return lines of two cable sections being connected to the respective intermediate node. For said change of the connection in response to said control signal no change of the hardware or software implementation is required.

It is advantageous that the multiplexers of subsequent intermediate nodes of the present invention are controlled by respectively inverted control signals assuming that the nodes are built up identically. The inverted control signals then ensure that the network interfaces are connected alternately between the forward lines and the return lines in the successive intermediate nodes.

Preferably, the n−1 cable sections form one cable having appropriate cable connectors for being connected to the connectors of the nodes of the bus network.

Finally, the invention is very useful if the forward and the return lines of at least of said n−1 cable sections are embodied as optical fibres. In that case the network nodes are embodied such that they are able to receive and/or transmit optical signals and to convert optical signals into electrical signals and vice versa.

Further advantageous embodiments of the invention are subject matters of the dependent claims.

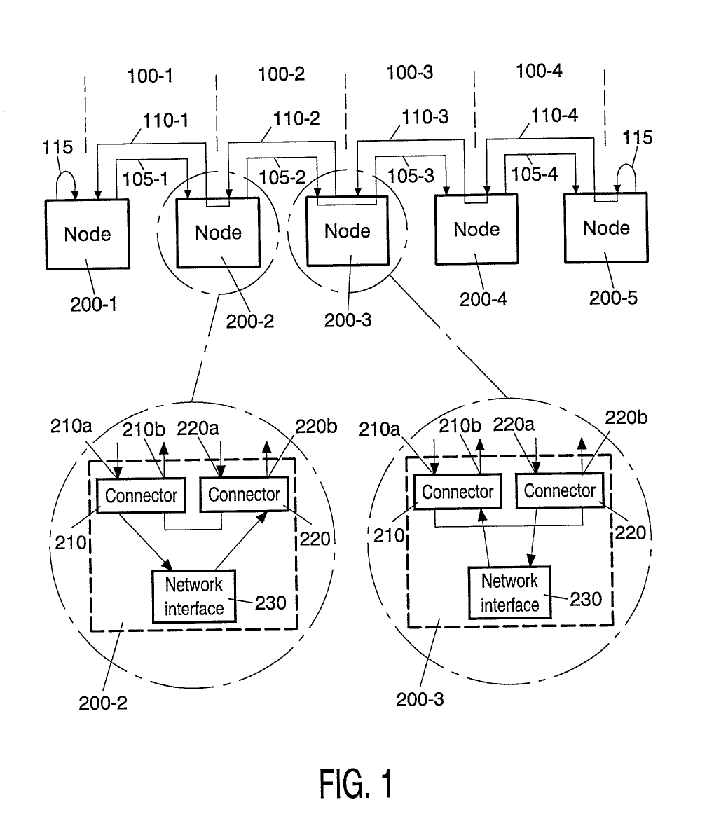

In the following advantageous embodiments of the invention are described by referring to FIGS. 1 to 6, wherein

FIG. 1 shows a ring network installed as bus network according to the present invention;

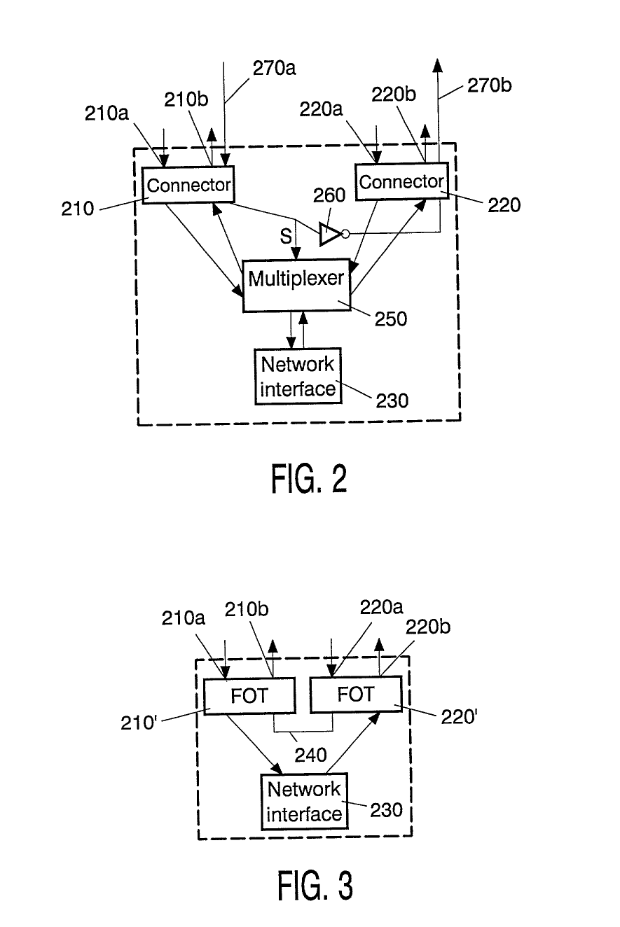

FIG. 2 shows an alternative embodiment of a node of the network according to the present invention;

FIG. 3 shows a further embodiment of a network node;

FIG. 4 shows a ring network installed as bus network known in the art; and

FIG. 5 shows an intermediate node known in the art.

FIG. 1 shows a ring network installed as bus network according to the present invention. It largely corresponds to the bus network known in the art and described above by referring to FIG. 4. Identical components are herein after referred to by the same reference numerals.

However, the bus network according to the present invention differs from the bus network known in the art in that the respective network interfaces 230 in said sequential intermediate nodes 200-2, 2003 and 200-4 are connected alternately between forward lines 105-1 . . . 105-4 and return lines 110-1 . . . 110-4 of the two cable sections being respectively connected to one intermediate node.

This is illustrated in FIG. 1 where the embodiment of node 200-3 differs from the embodiment of node 200-2. More specifically, in node 200-2 the network interface 230 is connected between the first input terminal 210a and the second output terminal 220b, i.e. between two forward lines, whereas in node 200-3 the network terminal is connected between a first output terminal 210b and a second input terminal 220a, i.e. between two return lines. Moreover, in node 200-2 a jumper 240 connects the first output terminal 210b with the second input terminal 220a whereas in node 200-3 the jumper 240 connects the first input terminal 210a with the second output terminal 220b.

According to the teaching of the present invention node 200-4 is embodied identical to node 200-2.

FIG. 2 shows an alternative embodiment for a node, in particular of an intermediate node of the bus network shown in FIG. 1. The first connector 210, the second connector 220 and the network interface 230 correspond to the identical components mentioned above by referring to FIG. 1, 4 and 5. In difference to the above described embodiments of a node the embodiment according to FIG. 2 comprises a multiplexer 250 being connected to the first input and output terminal 210a, 210b, to the second input and output terminal 220a, 220b and bidirectionally to the network interface 230. Said multiplexer 250 either switches said network interface 230 between the first input terminal 210a and the second output terminal 220b, i.e. between two forward lines or between the second input terminal 220a and the first output terminal 210b, i.e. between two return lines in response to a control signal. Moreover, said multiplexer 250 provides a jumper between these terminals which are in a particular case not connected via said network interface 230.

Due to the described flexibility of changing the connection of said network interface 230 said node including the multiplexer might be used for all intermediate nodes of the bus network according to the bus network described in FIG. 1. An installation according to the present invention is then achieved by providing respectively inverted control signals to the multiplexers of successive intermediate nodes. These specific signals ensure that the respective network interfaces 230 in said intermediate nodes are connected alternately between the forward lines and the return lines.

The provision of said control signals can easily be realised by providing only one control signal via a control wire 270a and the first connector 210 to the multiplexer 250 of for example the first intermediate node 200-2. The third embodiment of node 200-2 comprises an inverter 260 for inverting said control signal before outputting it via the second connector 220 and a second control wire 270b to the successive intermediate node 200-3.

The cable sections, in particular the return lines 110-1 . . . 110-4 and the forward lines 105-1 . . . 105-4 may be embodied e.g. as electrical or optical cable sections.

FIG. 3 shows a particular embodiment of an intermediate node being connected to two cable sections which are embodied as optical fibres. In that case the connector 210′ is embodied as optic to electrical converter and the second connector 220′ is embodied as electrical to optic converter, both being in FIG. 3 referred to as fibre optic transceiver FOT. Of course also the connectors 210 and 220 in the node-embodiment according to FIG. 2 can be replaced by said FOTs in the case that the cables connected to said node are optical fibres.

The main advantage of the switching of the nodes according to the invention shall now be explained for the network shown in FIG. 1 irrespective of the fact as to whether the intermediate nodes are embodied according to FIGS. 1, 2 or 3. However, only for purpose of illustration it is assumed that in the intermediate node 200-2 the network interface is connected between the two forward lines and that in the intermediate node 200-3 the network interface is connected between the two return lines 210-3, 210-2.

Assuming that the maximum wiring distance between two nodes for either a forward line or a return line is 50 m between two nodes it can be seen from FIG. 1 that in that case the maximum distance between node 200-1 and 200-4 now is larger than 50 m.

More specifically, in that example the maximum length of the return lines 100-1 and 100-2 between nodes 200-1 and 200-3 is restricted to 50 m because these two return lines are only connected via the jumper but not via a network interface for regenerating a signal. Moreover, the same applies to the maximum length of the forward lines between nodes 200-2 and 200-4. Consequently, the maximum wiring distance between nodes 200-2 and 200-4 is restricted to 50 m with the result that the maximum length between nodes 200-1 and 200-4 is larger than 50 m.

1. Ring network being installed as bus network, comprising:
n≧4 nodes (200-1, . . . 200-5); and
n−1 cable sections (100-1, . . . 100-5), in particular optical fibres, each of which including a forward line (105-1, . . . 105-4) and a return line (110-1, . . . 110-4) for transmitting a signal in opposite directions within said cable section;
wherein at least two of said nodes are intermediate nodes (200-2, 200-3, 200-4) being respectively connected between two of said cable sections such that the intermediate nodes are arranged in a sequential order, wherein a network interface (230) of each of said intermediate nodes (200-2, 200-3, 200-4) is connected either between the forward lines (105-1, . . . 105-4) or between the return lines (110-1, . . . 110-4) of said two connected cable sections for restoring the signal on the respective lines; and
wherein the first (200-1) and the last (200-5) of said nodes are respectively connected to only one of said cable sections (100-1, 100-4) and serve for closing the ring network by respectively connecting said return line (110-1, 110-4) with the forward line (105-1, 105-4) of said only one cable section;
characterized in that
in said at least two sequential intermediate nodes (200-2, 200-3, 200-4) the respective network interfaces (230) are connected alternately between the forward lines (105-1, . . . 105-4) and the return lines (110-1, . . . 110-4) of said two connected cable sections.

2. The ring network according to claim 1, characterized in that the each of the intermediate nodes (200-2, . . . 200-4) comprises at least one connector (210, 220) for being connected said two connected cable sections (100-1, . . . 100-4).

3. The ring network according to claim 2, characterized in that the at least one connector (210, 220) of each intermediate node (200-2, . . . 200-4) comprises a first input terminal (210a) for connecting the forward line (105-1, . . . 105-4) of a first one of said two cable sections (100-1, 100-2; 100-2, 100-3; 100-3, 100-4) to the intermediate node, a first output terminal (210b) for connecting the return line of said first cable section, a second input terminal (220a) for connecting the return line of the second one of said two cable sections and a second output terminal (220b) for connecting the forward line of said second cable section to the intermediate node.

4. The ring network according to claim 3, characterized in that in the case that the network interface (230) of one intermediate node (200-2, 200-3, 200-4) is connected between said first input (210a) and the second output terminal (220b), said intermediate node comprises a jumper (240) for connecting the second input (220a) with the first output terminal 210b).

5. The ring network according to claim 3, characterized in that in the case that the network interface (230) in one intermediate node (200-2, . . . 200-4) is connected between the second input (220a) and the first output terminal (210b), said intermediate node comprises a second jumper (240) for connecting the first input (210a) with the second output terminal (220b).

6. The ring network according to claim 3, characterized in that at least one of the intermediate nodes (200-2, . . . 200-4) comprises a multiplexer (250) for connecting the network interface (230) either between the first input (210a) and the second output terminal (220b) or between the second input (220a) and the first output terminal (210b) in response to a control signal.

7. The ring network according to claim 6, characterized in that the multiplexers (250) of subsequent intermediate nodes (220-2 . . . 220-4) are controlled by respectively inverted control signals.

8. The ring network according to one of claims 1 to 7, characterized in that the first (200-1) and/or the last node (200-5) respectively comprise a loop back terminator (115) for connecting the received forward line (105-1, 105-4) with the received return line (110-1, 110-4).

9. The ring network according to one of claims 1 to 8, characterized in that said n−1 cable sections (100-1, . . . 100-4) form one cable having appropriate cable connectors for being connected to the connectors (210, 220) of the nodes.

10. The ring network according to one of claims 1 to 9, characterized in that the forward (105-1, . . . 105-4) and the return line (110-1, . . . 110-4) of at least one of said n−1 cable sections (100-1, . . . 100-4) are embodied as optical fibres and that the nodes to which said optical fibres are connected comprise at least one fibre optical transceiver FOT (210′, 220′) for transforming an optical signal on said forward line ( 105-1 . . . 105-4) or on said return line (110-1 . . . 110-4) into an electrical signal before being sent to said network interface (230) or for transforming another electrical signal coming from said network interface into another optical signal for being sent to said forward or return line.
